(19) United States
(12) Patent Application Publication
(10) Pub. No.: US 2003/0133741 A1
(43) Pub. Date: Jul. 17, 2003

(54) Document binder for covers with heat activated adhesive

(76) Inventor: James Mark Folster Johnstone, Augusta Country Estate (ZA)

Correspondence Address: ANDREW M. HILL, 2101 CRYSTAL PLAZA ARC., PMB 160, ARLINGTON, VA, 22202, US

(21) Appl. No.: 10/045,164

(22) Filed: Jan. 15, 2002

(51) Int. Cl. B42F 3/02; B42F 13/02; B42F 13/00

(52) U.S. Cl. 402/19

(57) ABSTRACT

A document binder employing thermally activated adhesive in the spine of a prefabricated cover is provided that has a chassis with a cavity for receiving a removable cassette holding a plurality of covers with their associated document pages therein in the generally vertical orientation with the spines lowermost. A heated plate is positioned within the chassis for engaging said spines carried by a loaded cassette in the operative position. Jogger means are provided for jogging the covers during or following a heating cycle, or both. Cassettes for use in the document binder are a particular feature.

### FIELD OF THE INVENTION

This invention relates to a document binder for use in effecting the binding of a sheaf of document pages or other sheets of paper in a prefabricated cover consisting of a front and rear cover sheet, joined together along the operatively rear edge by a spine. The inside surface of the spine has thereon a heat activated adhesive, usually in the form of a hot melt type of adhesive. The spines, and often also the cover sheets, are generally made of paper board and/or plastics material and the spine is usually of a channel shape of a width that varies according to the number of pages or sheets to be bound therein.

### BACKGROUND TO THE INVENTION

Binding using prefabricated covers of the type outlined above is carried out by inserting a sheaf of pages to be bound into a cover having a spine of an appropriate width and resting the spine of the cover on a heated plate with the spine lowermost and the documents and cover sheets in a generally vertical orientation. This enables the heat activated adhesive on the inside of the spine to bond to the edges of the documents located in the cover.

The document binder used to effect this binding operation, in instances in which relatively low volumes of production are required, is typically a manual binder simply presenting one or two slots into which one or more covers can be inserted in the correct orientation. A heated plate at the bottom of the slots then melts or otherwise activates the adhesive. The achievement of a high quality bind is dependant upon the constant attention of the operator. On the other hand, in situations requiring a high production rate, automatic machines are employed into which covers of the type described are fed in the generally vertical orientation, as described above. The covers are conveyed through the machine on a substantially continuous basis using a variety of different conveying mechanisms. Also, these machines generally have jogger means, typically jogger plates, for applying a series of a sharp movements to the cover and documents within it in an effort to ensure that the edges of all of the documents bond to the adhesive, and thus to the spine.

As these machines operate on a substantially continuous basis they require constant attention whilst loaded covers are being fed to them. As a general rule, various covers and associated documents originate from different work stations and, as a result, after binding, they must be identified and sorted in order to be returned to their points of origin or for distribution otherwise.

### OBJECT OF THE INVENTION

It is an object of this invention to provide a document binder and adjunct thereof which may be configured to be more versatile than existing automatic machines but which nevertheless provides for the binding of multiples of cover and document assemblies without hands on attention of an operator to achieve a satisfactory bind every time.

### SUMMARY OF THE INVENTION

In accordance with one aspect of this invention there is provided a document binder comprising a chassis having a cavity for receiving a removable cassette, and wherein the cassette is configured to hold a plurality of covers with their associated document pages therein in the generally vertical orientation with the spines lowermost, a heated plate positioned within the chassis for engaging said spines with a loaded cassette in the operative position, and jogger means for jogging the covers during or following a heating cycle, or both.

Further features of this aspect of the invention provide for the chassis to have a generally horizontal track communicating with the cavity and adapted to support a cassette during movement thereof along the track into and out of the cavity; for the heated plate to be movable in a generally vertical direction between, a lower inoperative position and an upper operative position in which it engages the spines of covers supported in a loaded cassette positioned within the cavity; for the jogger means to comprise jogger plates adapted to engage at least the top edges of the covers and optionally also the end edges and to impart a jogging action thereto with each plate, if there be more than one, preferably engaging its associated series of edges of the covers sequentially; for conveyor means to be provided for moving a loaded cassette along the track into and out of said cavity; and for the conveyor means and track to be arranged either such that a cassette passes from one end of the chassis through the cavity and then out of the other end of the chassis or, alternatively, a loaded cassette is moved into and out of the cavity with a forward and reverse motion.

In accordance with a second aspect of the invention there is provided a cassette for use with a document binder as defined above, the cassette having a series of dividers defining a series of juxtaposed and generally operatively vertically orientated open topped and substantially open bottomed compartments adapted to receive covers with documents therein in a generally vertical orientation with the spine lowermost; means at the bottom of each compartment for supporting the spine of each of the covers positioned within a loaded cassette whilst exposing the major portion of each spine for contact by a heated plate or the like, and means for supporting the cassette within the cavity of a document binder as defined above.

Further features of this aspect of the invention provide for the dividers to be connected to each other by means of interconnecting frame members extending along the sides of the cassette in both upper and lower regions thereof whilst leaving open an intermediate zone of the sides for enabling any side jogger plates to contact the edges of covers within the cassette; for the upper frame members to have outwardly directed flanges which serve as handles whereby the cassette can be manually lifted and carried; for the means for supporting the spine of each cover within the cassette to be an inwardly directed lip carried by the lower frame member at each side of the cassette to thereby support the spines at each of their ends; for the lower frame members to have supporting wheels for cooperation with the generally horizontal track in a machine; and for the total height of the compartments of the cassette to be somewhat less than the total corresponding dimension of the covers.

In order that the above and other features of the invention may be more fully understood one embodiment thereof will now be described with reference to the accompanying drawings.

### BRIEF DESCRIPTION OF THE DRAWINGS

In the drawings:

FIG. 1 is an isometric view of a cassette for use as an adjunct to a document binder according to the invention;

FIGS. 2a and 2b are schematic side elevations of one form of document binder according to the invention with FIG. 2a showing the machine alone and FIG. 2b showing a cassette in position in the machine;

FIG. 3 is a schematic end view of a loaded cassette showing the co-operation thereof with the heated plate and jogger plate of the document binder; and,

FIG. 4 is a schematic side illustration of a different embodiment of binder according to the invention in which the cassette passes from one end of the machine to the other instead of in a forward and reverse direction.

### DETAILED DESCRIPTION WITH REFERENCE TO THE DRAWINGS

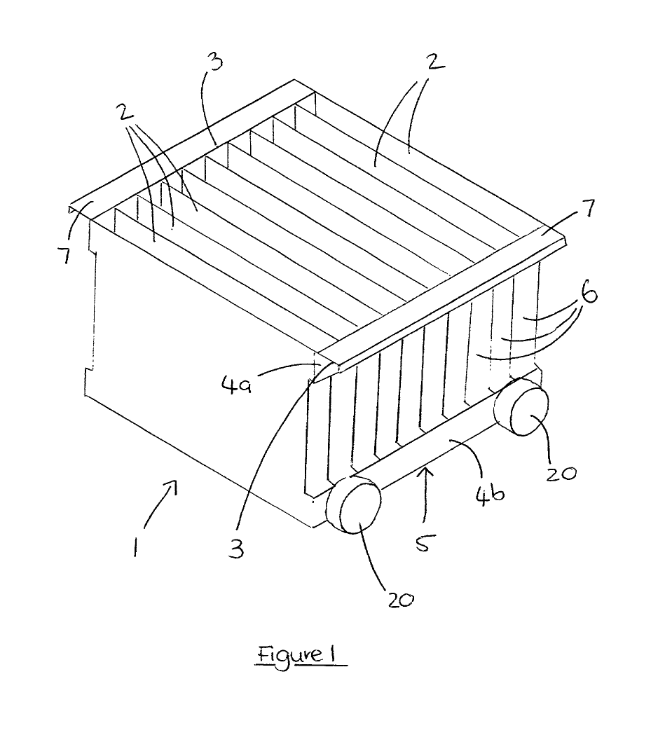

In the embodiment of the invention illustrated in FIGS. 1 to 3 of the drawings a document binder is particularly configured as a desk top model and it is therefore designed to be as small as possible as will become apparent from the following description. However, it is also intended that the invention be applied to free standing models for larger applications. In either case, the configuration of the cassettes for use with the document binder is of prime importance and a typical cassette will therefore be described initially.

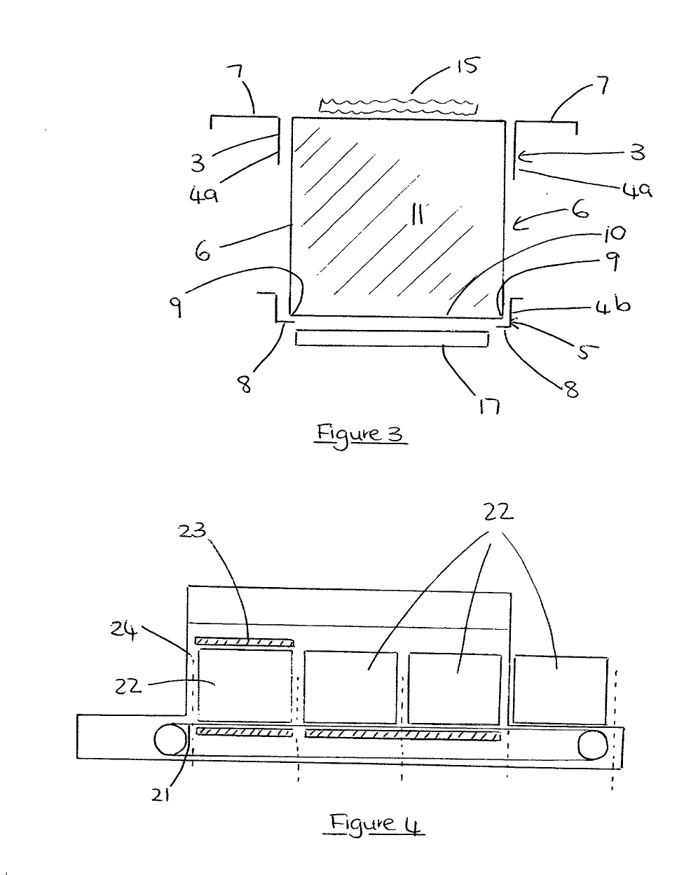

Referring therefore to FIGS. 1 and 3 of the drawings, a cassette, generally indicated by numeral (1), comprises a series of parallel divider plates (2) spaced apart by a suitable distance which may range between 3 mm and 50 mm but which is typically about 30 mm for general-purpose application. In the operative orientation illustrated, the plates are vertically orientated and define between each pair of plates a compartment having an open top and an open bottom. The plates are interconnected at each of their upper ends by an upper frame member (3) which defines the upper part (4a) of a side wall and at their lower ends by a lower frame member (5) which defines the lower portion (4b) to the side wall. In between the upper and lower frame members (3) and (5) the sides of the compartments are open, as indicated by numeral (6). This is economical; enables the ends of the covers in a cassette to be viewed; and provides that the end edges of covers located therein will be accessible to lateral jogger plates in the event that the particular machine has such jogger plates.

The upper frame member (3) has, in each case, a generally horizontally outwardly directed flange (7) with a down-turned lip so that the flanges serve as convenient and comfortable handles whereby the cassette may be manually lifted and carried.

The lower frame member (5) has, in each case, and inwardly directed lip (8) (see FIG. 3) extending along its lower edge, the lip being adapted to support the ends (9) of the spine (10) of a cover (11) when the cover is located in a compartment. It will therefore be appreciated that a series of covers with their documents positioned therein may be loaded into a cassette at a remote location in preparation for binding and that a plurality of covers, depending on the thickness thereof, can be located in each compartment, as may be required.

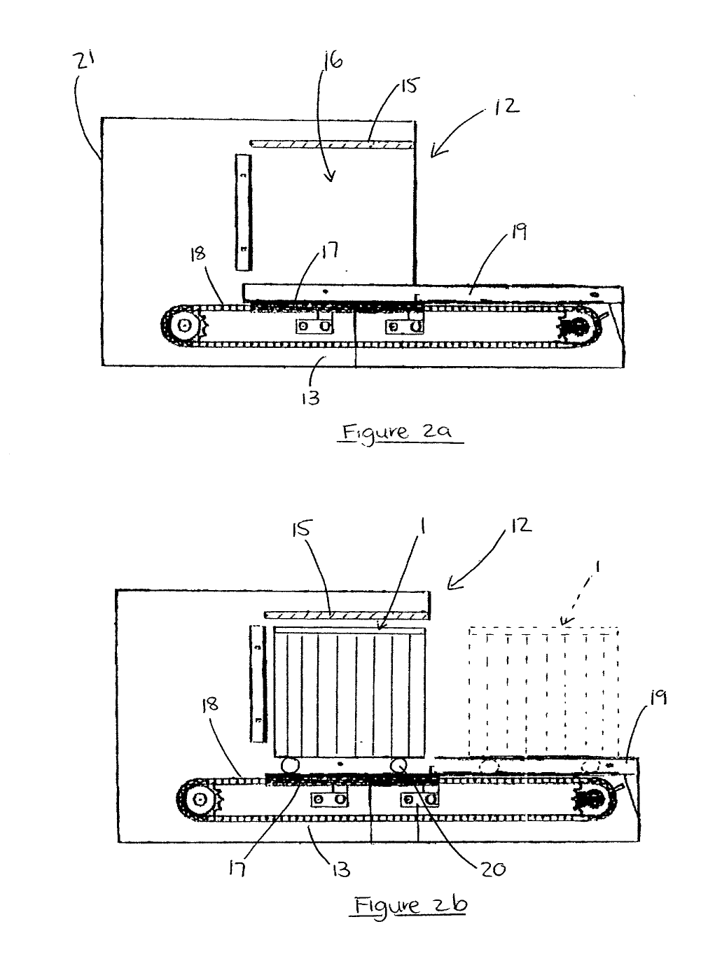

Turning now to the document binder itself, and with reference more particularly to FIGS. 2a and 2b of the drawings, a document binder generally indicated by numeral (12) is configured as a desk top model and has a chassis (13) supporting a top jogger plate (15) located at the top of a cavity generally indicated by numeral (16). At the bottom of the cavity is a heated plate (17) that is mounted in a manner such that it has a lower inoperative position and a raised upper operative position.

A conveyor (18) and track (19) define support means for supporting and moving a cassette into and out of the cavity from the same side of the machine by means of forward and reverse movements of the conveyor. In order to facilitate this the cassette is provided with support wheels (20) that cooperate with the track to support the weight of the loaded cassette. With a loaded cassette positioned on the track the conveyor control means which are conveniently located at the rear (21) of the machine cause the cassette to move into the cavity.

Once in this position the heated plate lifts from its inoperative position to its first operative position in which it engages the spines of the covers and lifts the covers slightly to ensure proper engagement of the heated plate with the spines. After a short heating phase the heated plate lifts abruptly to a second elevated position and down again so that the covers strike the top jogger plate that he is stationary. This procedure is repeated a number of times say between 5 and 8. In this manner the documents within the covers are vibrated to ensure that the documents all tend to move such that they lower edges bond with the now melted adhesive in well-known manner. At the end of the cycle the heated plate becomes lowered to its inoperative position and the conveyor reverses to move the cassette back along the track and present it with the bound documents in their covers for removal as a unit.

It will be understood that a number of cassettes can be used with one document binder and that considerable flexibility is inherent in the document binder system. Thus, for example, any one of many workers can be allocated one or more cassettes for their use and the cassette can be marked appropriately. Each worker can prepare one ore more entire loaded cassettes at a workstation remote from the document binder and can, as and when suitable or scheduled, carry the loaded cassettes to the document binder in order to carry out the binding. Thereafter, the worker can remove each loaded cassette and use it as a means to carry the bound documents to their destination or back to the workstation. A highly efficient system is therefore envisaged. It will also be understood that numerous variations may be made to the embodiment of the invention described above which is simply illustrative of the invention and not intended to be limiting in any way. In particular, the design and configuration of the cassette can be varied widely as can the document binder itself.

In this regard, and as illustrated in FIG. 4, the conveyor mechanism (21) could be made to transport a succession of in cassettes (22) through the machine to the other side. In this case a single job a plate (23) is provided so that jogging can be effected after a liquid heating and prior to discharge of the cassette at the outlet end (24). The latter type of arrangement is considered to be more appropriate to higher volume production than the desk top model described above.

1. A document binder comprising a chassis having a cavity for receiving a removable cassette, and wherein the cassette is configured to hold a plurality of covers with their associated document pages therein in the generally vertical orientation with the spines lowermost, a heated plate positioned within the chassis for engaging said spines with a loaded cassette in the operative position, and jogger means for jogging the covers during or following a heating cycle, or both.

2. A document binder as claimed in claim 1 in which the chassis has a generally horizontal track communicating with the cavity and adapted to support a cassette during movement thereof along the track into and out of the cavity.

3. A document binder as claimed in claim 1 in which the heated plate is movable in a generally vertical direction between a lower inoperative position and an upper operative position in which it engages the spines of covers supported in a loaded cassette positioned within the cavity.

4. A document binder as claimed in claim 3 in which the heated plate is movable to a first raised position in which it supports the spines of covers in a cassette during a heating cycle and a second raised position in which it causes the covers to impact a fixed jogger plate.

5. A document binder as claimed in claim 1 in which the jogger means comprise a jogger plate adapted to engage at least the top edges of the covers.

6. A document binder as claimed in claim 1 in which conveyor means is provided for moving a loaded cassette along the track into and out of said cavity.

7. A document binder as claimed in claim 6 in which the conveyor means and track are arranged such that a cassette passes from one end of the chassis through the cavity and then out of the other end of the chassis.

8. A document binder as claimed in claim 6 in which the conveyor means and track are arranged such that a cassette is moved into and out of the cavity with a forward and reverse motion.

10. A cassette for use with a document binder as claimed in any one of the preceding claims, the cassette having a series of dividers defining a series of juxtaposed and generally operatively vertically orientated open topped and substantially open bottomed compartments adapted to receive covers with documents therein in a generally vertical orientation with the spine lowermost; means at the bottom of each compartment for supporting the spine of each of the covers positioned within a loaded cassette whilst exposing the major portion of each spine for contact by a heated plate or the like, and means for supporting the cassette within the cavity of a document binder as defined above.

11. A cassette as claimed in claim 10 in which the dividers are connected to each other by means of interconnecting frame members extending along the sides of the cassette in both upper and lower regions thereof.

12. A cassette as claimed in claim 11 in which the upper frame members have outwardly directed flanges which serve as handles whereby the cassette can be manually lifted and carried.

13. A cassette as claimed in claim 10 in which the means for supporting the spine of each cover within the cassette is an inwardly directed lip carried by a frame member at each side of the cassette to thereby support the spines at each of their ends.

14. A cassette as claimed in claim 10 in which the cassette has supporting wheels for cooperation with the generally horizontal track in a machine.
